(19) United States
(12) Patent Application Publication
(10) Pub. No.: US 2023/0383771 A1
(43) Pub. Date: Nov. 30, 2023

(54) Bidirectional Valve System for Bidirectional Servocontrolled Motion

(71) Applicant: William Gilmore, Fairhaven, MI (US)

(72) Inventor: William Gilmore, Fairhaven, MI (US)

(21) Appl. No.: 18/231,302

(22) Filed: Aug. 8, 2023

Related U.S. Application Data
(63) Continuation of application No. 17/944,565, filed on Sep. 14, 2022, now abandoned.
(60) Provisional application No. 63/243,788, filed on Sep. 14, 2021.

(51) Int. Cl. F15B 15/14; F15B 13/04

(52) U.S. Cl. CPC F15B 15/1428; F15B 13/0401; F15B 2211/30525; F15B 2013/0413; F16F 9/062

(57) ABSTRACT

The system is an improved valve/actuator architecture using a 4-way blocked-port architecture and area asymmetry providing numerous advantages over the conventional practice. The system uses fewer control circuits and provides for reduced component parts—it reduces hose, tubing and fitting requirements (lower cost, improved packaging, less installation labor and less leakage due to fewer connections). It also eliminates the need for a spring for static load support and other suspension control components (such as a sway bar). The system simplifies the mechanical design thereby reducing cost, aids in packaging, eliminates hysteresis losses of the spring and reduces moving mass thereby lowering response time. The system further allows regeneration of hydraulic power thereby increasing overall efficiency. The system further eliminates one half of throttling loss in a servo-valve.

### CROSS REFERENCE TO RELATED APPLICATIONS

This application claims priority and benefit to Provisional Patent Application Ser. No. 63/243,788 filed on Sep. 14, 2021.

### TECHNICAL FIELD

The present disclosure relates generally to valves. More specifically, the present disclosure relates to a bidirectional valve system

### BACKGROUND

Prior known valves for use in vehicles are used in connection with suspension springs, sway bars, and shock dampers using a double-acting hydraulic cylinder, in combination with an integral, cap-end mounted three-way servo-valve, also incorporating its gas-over-fluid accumulator. Many systems require a spring element to support the static load in at a neutral or ‘center’ position. While this geometry is also somewhat regenerative (only to the extent of lowering the input power requirement in one direction, it does not return any power to the prime mover. Also, a spring is inherently lossy, due to hysteresis, with the energy lost as heat).

FIG. 1, prior art, discloses Onventional Valving for Bidirectional Servocontrolled Motion. et-pipe-type servovalves Require internal control supply to have a reverse check valve to prevent drawdown of operating pressure under power-down conditions. Servovalves are customarily shown with closed center porting. This is subject to design-driven modification to manage zero-crossover response.

Accordingly, there exists a need in the art to provide an improved valve/actuator architecture and corresponding system and method of operation.

### SUMMARY

The system is an improved valve/actuator architecture using a 4-way blocked-port architecture and area asymmetry providing numerous advantages over the conventional practice. The system uses fewer control circuits and provides for reduced component parts—it reduces hose, tubing and fitting requirements (lower cost, improved packaging, less installation labor and less leakage due to fewer connections). It also eliminates the need for a spring for static load support and other suspension control components (such as a sway bar). The system simplifies the mechanical design thereby reducing cost, aids in packaging, eliminates hysteresis losses of the spring and reduces moving mass thereby lowering response time. The system further allows regeneration of hydraulic power thereby increasing overall efficiency. The system further eliminates one half of throttling loss in a servo-valve.

A bidirectional valve system by bidirectional servovontolled motion, the system having an actuator, the actuator having a valve connected directly thereto, the valve being a three-way hydraulic valve (the equivalent of a blocked port 4-way servevalve), a system return extends away from the valve, a supply extends away from the valve, a concentric internal accumulator, a control pressure, a concentric accumulator gas charge, a system pressure (supply to accumulator and from accumulator), a system supply pressure (LAcumulator), a system supply pressure (load support), and in actuator in fluid communication with the actuator to improve efficiency. The bidirectional valve system may be mounted directly to a cylinder. The bidirectional valve system may be a triple wall construction.

The benefit is that there is increased efficiency because there is only one pass through the valve which reduces the losses through the valve by half and accounts for half of the valving losses. Also, by using this asymmetrical arrangement in a cylinder, it offers the support of an overhung load (automotive body over wheels) and eliminates the need for spring suspension. The entire design encompasses incorporating the valve into the actuator for higher frequency response.

A bidirectional valve system by bidirectional servovontolled motion, the system having an actuator, the actuator having a valve connected directly thereto, the valve being a four-way hydraulic valve, a system return extends away from the valve, a supply extends away from the valve, a concentric internal accumulator, acontrol pressure, a concentric accumulator gas charge, a system pressure (supply to accumulator and from accumulator), a system supply pressure (LAcumulator), a system supply pressure (load support), and in actuator in fluid communication with the actuator to improve efficiency. The bidirectional valve system may be mounted directly to a cylinder. The bidirectional valve system may be a triple wall construction. The bidirectional valve system may be mounted directly to a cylinder. The bidirectional valve system may be a triple wall construction.

The benefit is that there is increased efficiency because there is only one pass through the valve which reduces the losses through the valve by half and accounts for half of the valving losses. Also, by using this asymmetrical arrangement in a cylinder, it offers the support of an overhung load (automotive body over wheels) and eliminates the need for spring suspension. The entire design encompasses incorporating the valve into the actuator for higher frequency response.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 (prior art) depicts a schematic diagram of a conventional valve system, for bidirectional servocontrolled motion as disclosed herein according to one or more embodiments shown and described herein;

FIG. 2 depicts a side view schematic hydraulic system, utilizing unconventional valve/actuator systems as disclosed herein according to one or more embodiments shown and described herein;

FIG. 3 depicts a side view schematic simplified three-way cartridge hydraulic servo valve as disclosed herein according to one or more embodiments shown and described herein;

FIG. 4 depicts a side view schematic accumulator into an actuator as disclosed herein according to one or more embodiments shown and described herein;

FIG. 5 depicts a side view triple wall construction of the design to facilitate accumulator supply as disclosed herein according to one or more embodiments shown and described herein;

FIG. 6 depicts a cross sectional view of triple wall construction of the design to facilitate accumulator supply as disclosed herein according to one or more embodiments shown and described herein;

FIG. 7 a side view schematic of the actuator on a pair of control arms according to one or more embodiments shown and described herein; and

FIG. 8 a side view schematic of the actuator on a pair of control arms according to one or more embodiments shown and described herein.

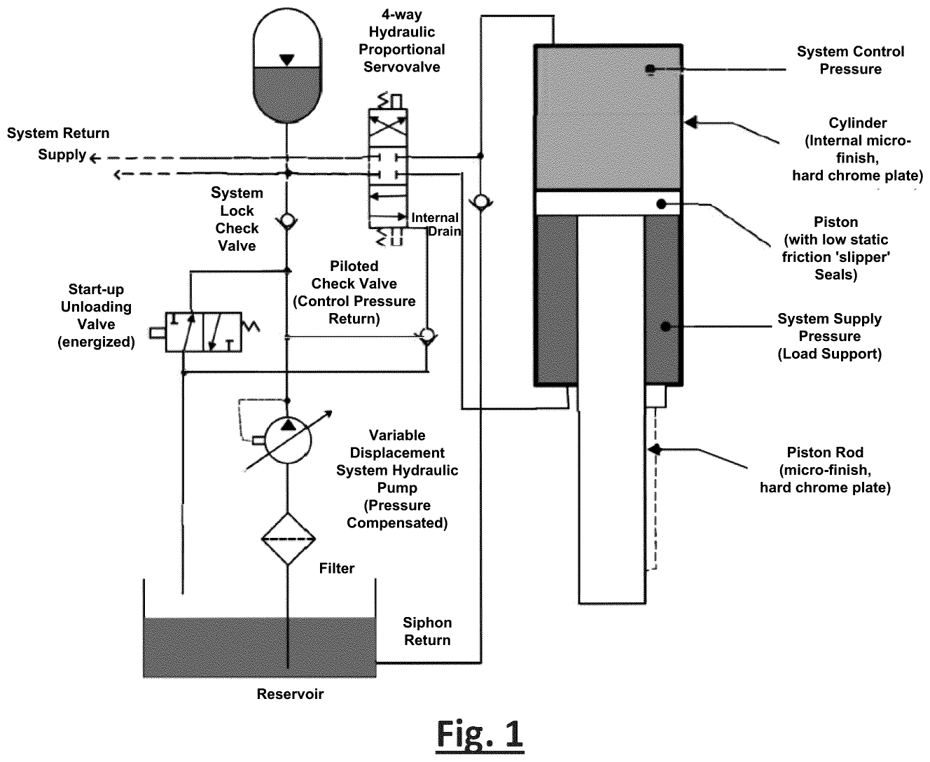

### DETAILED DESCRIPTION

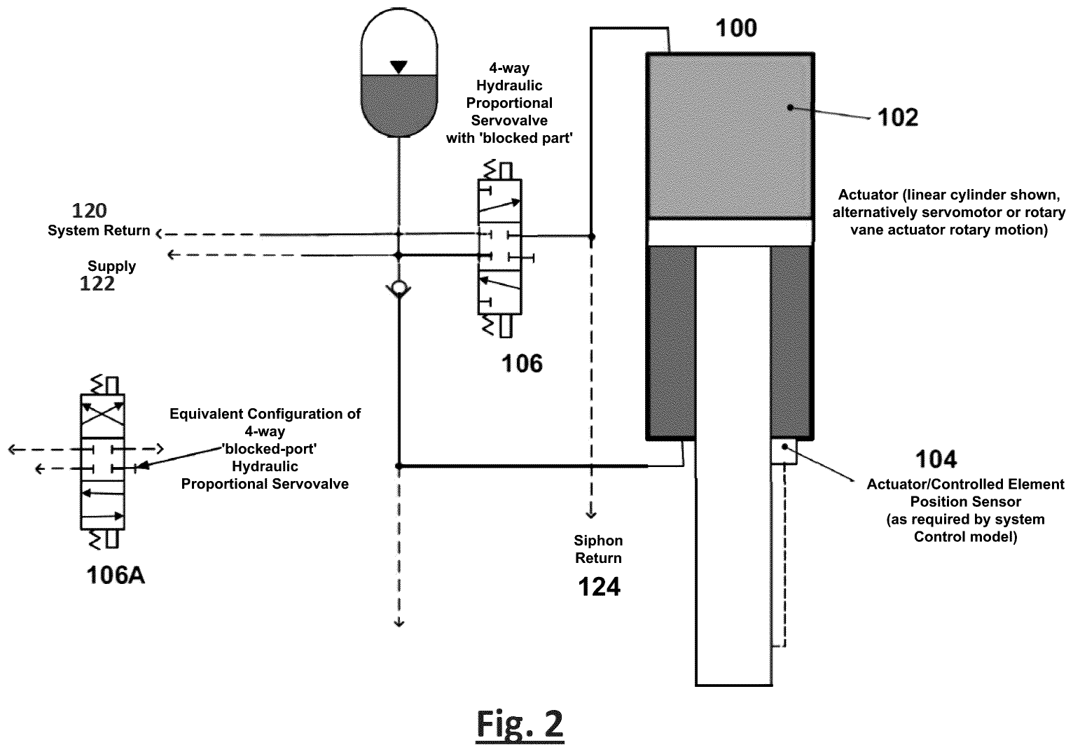

While several points of novelty are discussed herein, the main apparatus and system described herein is an improved valve/actuator architecture. The present system as disclosed herein, and as illustrated in FIGS. 2-5, uses 4-way blocked-port architecture and area asymmetry providing numerous advantages over the conventional practice.

The present system as disclosed herein uses fewer control circuits and provides for reduced component parts—it reduces hose, tubing and fitting requirements (lower cost, improved packaging, less installation labor and less leakage due to fewer connections). It also eliminates the need for a spring for static load support and other suspension control components (such as a sway bar). As shown in the appended figures, it simplifies the mechanical design thereby reducing cost, aids in packaging, eliminates hysteresis losses of the spring and reduces moving mass thereby lowering response time. The system further allows regeneration of hydraulic power thereby increasing overall efficiency. The system further eliminates one half of throttling loss in a servo-valve.

FIG. 2 discloses the hydraulic system 100 schematic utilizing unconventional valve structure for bidirectional and regenerative servocontrolled motion. FIG. 2 is a Novel Hydraulic System Architecture utilizing Unconvemtional Valving for Bidirectional, Regererative Servocontrolled Motion. An actuator 102 is provided being a linear cylinder as shown. In other embodiments, the actuator may be sorvomotor or rotary vane actuator for rotary motion. An actuator element position sensor 104 is provided as required by the system control mode. The valve 106 illustrates a three-way hydraulic valve novel to the present configuration. Alternatively, a 4-way blocked port hydraulic proportional servovalve 106A may be provided. The flow arrows as depicted in FIG. 2 demonstrate the flow of fluid through the system. FIG. 2 depicts a system 100 having an actuator 102 where the actuator is a linear cylinder as shown. Alternatively, a servomotor or rotary vane actuator for rotary motion may be used. An actuator 104 is connected to the actuator 102. The actuator 104 maybe a controlled element sensor such as required by the system control model. A 4-way hydraulic Proportional servovalve with blocked poet 106 is also provided. a system return 120 extends away from. A supply 122 also extends away from 106. An alternative blocked port 106A is provided as a hydraulic proportional servovalve. A siphon return 124 is also provided.

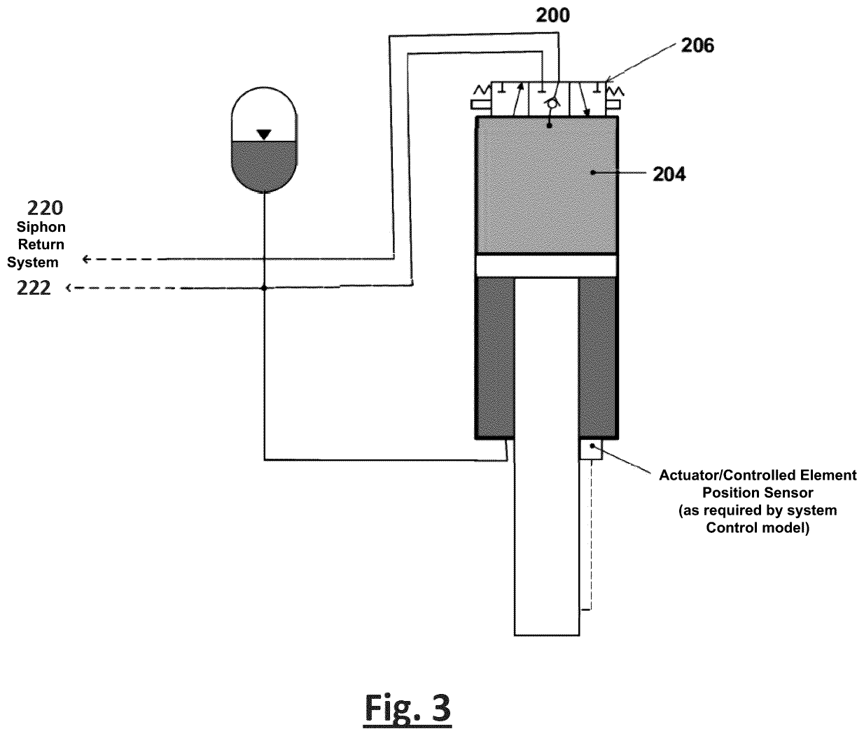

FIG. 3 depicts a simplified three-way cartridge hydraulic servovalve with the manifold/valve 206 mounted directly to the cap at the end of the cylinder 204. FIG. 3 is a Simplified Three-way Cartridge Hydraulic Servo valve (manifold mounted directly to cap end of cylinder). FIG. 3 depicts a system 200 having an actuator 304 where the actuator is a linear cylinder as shown. Alternatively, a servomotor or rotary vane actuator for rotary motion may be used. An actuator 214 is connected to the actuator 204. The actuator 214 maybe a controlled element sensor such as required by the system control model. A 4-way hydraulic Proportional servovalve with blocked port 206 is also provided. A system return 220 extends away from. A supply 222 also extends away from the system.

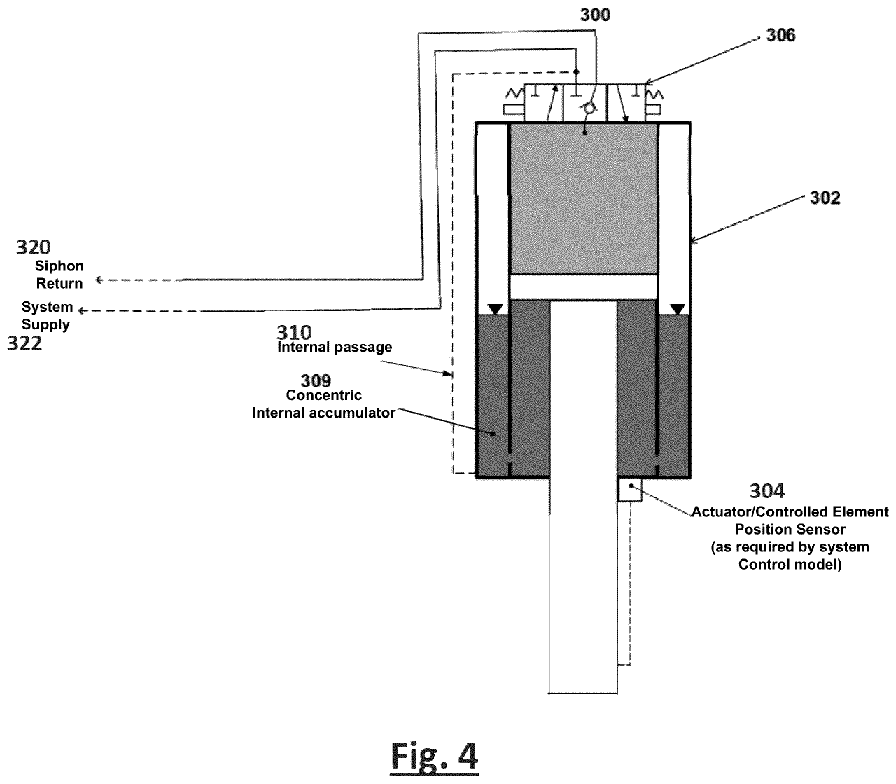

FIG. 4 depicts an alternative embodiment wherein the system 300 includes the actuator 302 having the manifold 306 mounted thereto wherein an accumulator 308 is incorporated therein. This configuration is used in gas shocks and struts. FIG. 4 is an illustration Incorporating accumulator into actuator, as in ‘gas shocks/struts’. FIG. 4 is a Simplified Three-way Cartridge Hydraulic Servo valve (manifold mounted directly to cap end of cylinder). FIG. 2 depicts a system 300 having an actuator 302 where the actuator is a linear cylinder as shown. Alternatively, a servomotor or rotary vane actuator for rotary motion may be used. An actuator 104 is connected to the actuator 302. The actuator 304 maybe a controlled element sensor such as required by the system control model. A 4-way hydraulic Proportional servovalve with blocked poet 306 is also provided. a system return 320 extends away from. A supply 322 also extends away from 106. A concentric internal accumulator 309 is also provided as well as an internal passage 310.

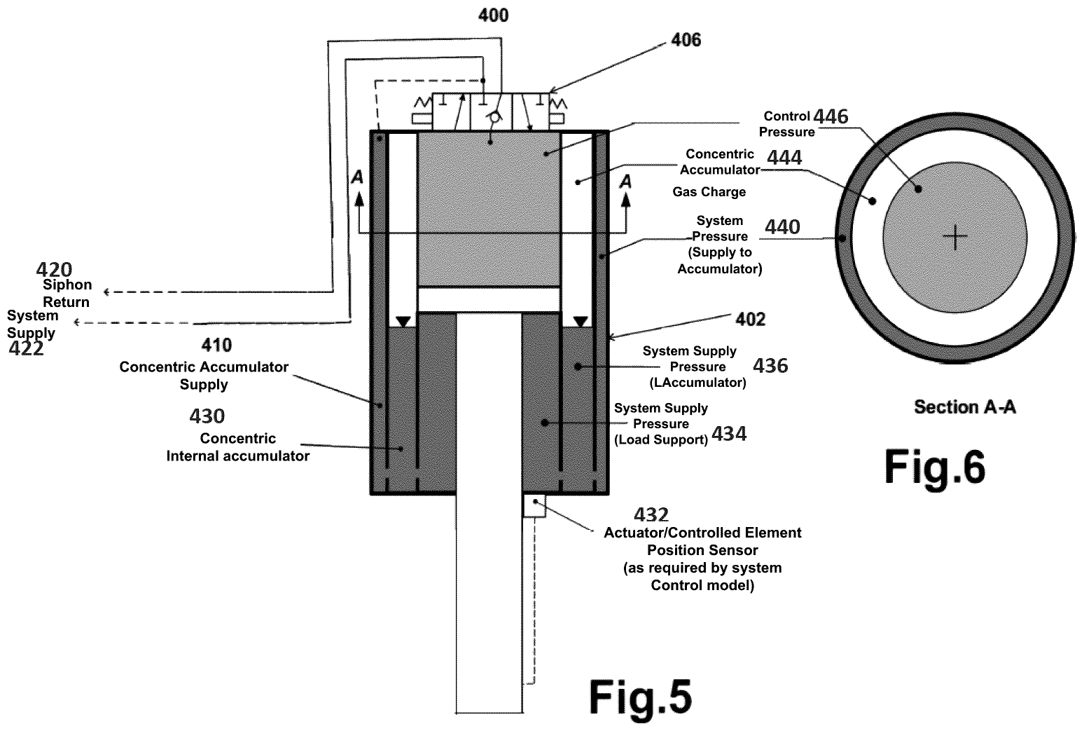

FIG. 5-7 depicts a system 400 wherein the actuator 402 is a triple wall construction 410 having the manifold 406 connected directly thereto. FIG. 5 is a Triple wall construction to facilitate accumulator supply internally. FIG. 6 is a cross sectional view of the embodiments as illustrated in FIG. 5. A system return 420 extends away from. A supply 422 also extends away from the system. The system further includes a concentric internal accumulator 430. A control pressure 446, a concentric accumulator gas charge 444, a system pressure (supply to accumulator and from accumulator) 440, A system supply pressure (LAcumulator) 436, A system supply pressure (load support) 334, and in actuator 432 are also provided. The actuator 432 so be a controlled element position sensor (as required by system control model).

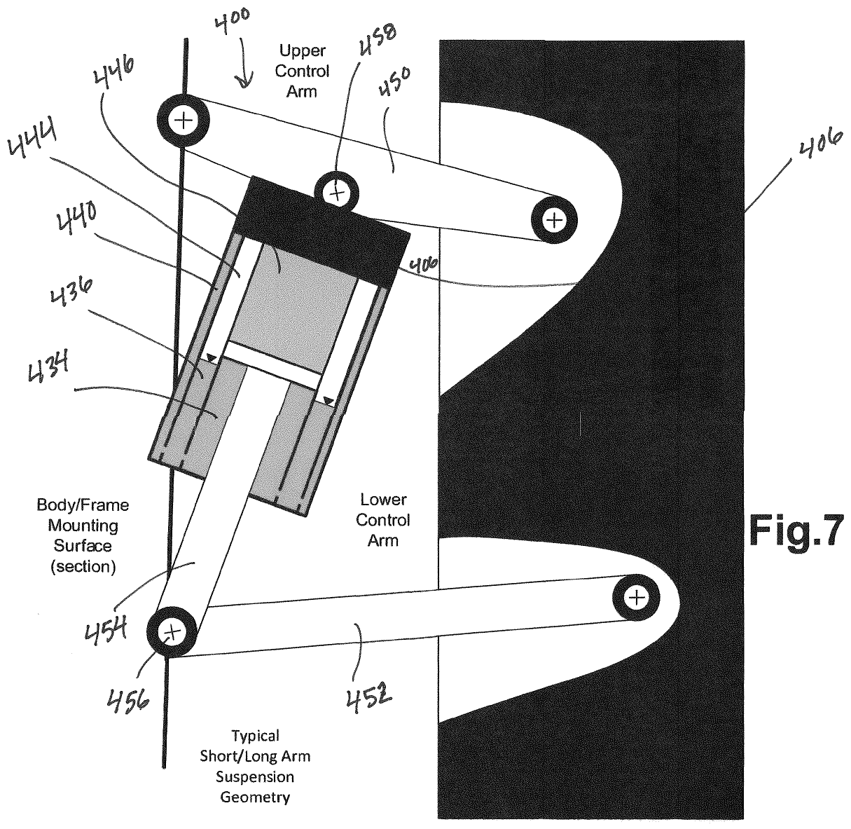

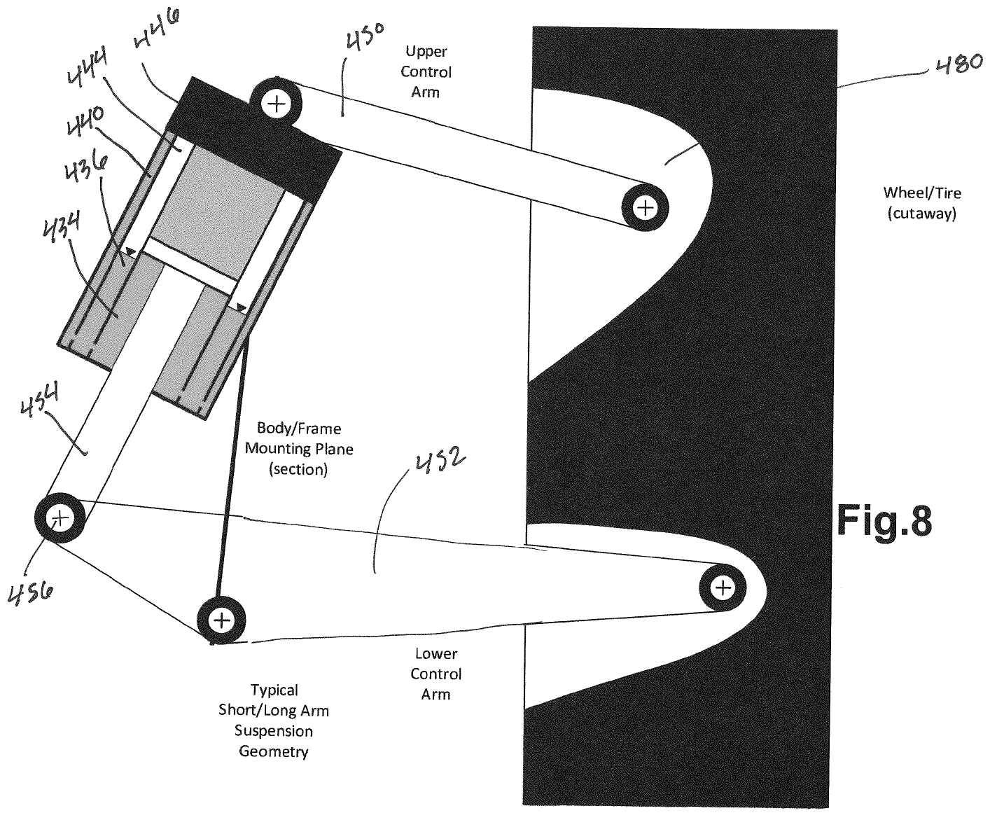

FIG. 7 illustrates the actuator in use on 2 control arms. FIG. 7 a side view schematic of the actuator on a pair of control arms according to one or more embodiments shown and described herein. FIG. 8 illustrates an alternative view of the actuator in use on 2 control arms. FIG. 8 a side view schematic of the actuator on a pair of control arms according to one or more embodiments shown and described herein. An upper control arm 450 and a lower control arm 452 connect the system 400 to the vehicle. The system provides for standard short/long arm suspension geometry in a vehicle. The opening 406 illustrates a wheel/tire cutaway allowing for movement in the system

By way of example, a system requiring some means to maintain a neutral or static position against the force of gravity, such as a wheeled (or tracked) vehicle, has traditionally used metallic or other springs to provide this positioning, as well as to improve the ride and handling of the vehicle as a whole. Inherent in implementing a ‘sprung mass’ design is the creation of a harmonic oscillator, with a natural or resonant frequency, dependent on the square root of k/m, where k is the spring rate of the restoring force and m is the sprung mass. This suspension requires the use of a velocity damper or ‘shock absorber’ to control oscillation, rebound and overshoot. These components are inherent loss, changing the suspension motion into heat, to be radiated away to no advantage to the system. The energy thus radiated may only be derived from the forward motion of the vehicle. This mechanization is the overwhelming standard for all ground transportation vehicles.

The present system as described herein replaces present spring, (and sway bar, if fitted) and shock damper with a deceptively similar double-acting hydraulic cylinder, in combination with an integral, cap-end mounted three-way servo-valve, also incorporating its gas-over-fluid accumulator, as in present design gas-assisted shocks and struts, utilizing existing triple wall design and manufacturing technology.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

The benefit is that there is increased efficiency because there is only one pass through the valve which reduces the losses through the valve by half and accounts for half of the valving losses. Also, by using this asymmetrical arrangement in a cylinder, it offers the support of an overhung load (automotive body over wheels) and eliminates the need for spring suspension. The entire design encompasses incorporating the valve into the actuator for higher frequency response.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consist of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims (and/or any future claims filed in any Utility application) cover all such changes and modifications that are within the scope of the claimed subject matter.

Moreover, although various aspects of the claimed subject matter have been described herein, such aspects need not be utilized in combination.

It is therefore intended that the appended claims cover all such changes and modifications that are within the scope of the claimed subject matter.

What is claimed is:

1. A bidirectional valve system by bidirectional servovontolled motion, the system comprising:
an actuator, the actuator having a valve connected directly thereto, the valve being a three-way hydraulic valve;
a system return extends away from the valve;
a supply extends away from the valve;
a concentric internal accumulator, acontrol pressure, a concentric accumulator gas charge, a system pressure (supply to accumulator and from accumulator), a system supply pressure (LAcumulator), a system supply pressure (load support), and in actuator in fluid communication with the actuator to improve efficiency.

2. The bidirectional valve system of claim 1 wherein the valve is mounted directly to a cylinder.

3. The bidirectional valve system of claim 1 wherein actuator is a triple wall construction.

4. A bidirectional valve system by bidirectional servovontolled motion, the system comprising:
an actuator, the actuator having a valve connected directly thereto, the valve being a four-way hydraulic valve;
a system return extends away from the valve;
a supply extends away from the valve;
a concentric internal accumulator, acontrol pressure, a concentric accumulator gas charge, a system pressure (supply to accumulator and from accumulator), a system supply pressure (LAcumulator), a system supply pressure (load support), and in actuator in fluid communication with the actuator to improve efficiency.

5. The bidirectional valve system of claim 4 wherein the valve is mounted directly to a cylinder.

6. The bidirectional valve system of claim 4 wherein actuator is a triple wall construction.
